(19) United States
(12) Patent Application Publication
(10) Pub. No.: US 2007/0182710 A1
(43) Pub. Date: Aug. 9, 2007

(54) Integrated material handling and displaying unit, system and method of use

(76) Inventors: Frederic MacDonald, Santa Monica, CA (US); Joel Hladecek, Los Angeles, CA (US); Norman DeCost, Midlothian, VA (US)

Correspondence Address: MCGUIREWOODS, LLP, 1750 TYSONS BLVD, SUITE 1800, MCLEAN, VA, 22102, US

(21) Appl. No.: 11/549,407

(22) Filed: Oct. 13, 2006

Related U.S. Application Data
(63) Continuation of application No. PCT/US05/12385, filed on Apr. 13, 2005.

(51) Int. Cl. G09G 5/00

(52) U.S. Cl. 345/156

(57) ABSTRACT

A food service article includes a feature for displaying data and method displaying data. The feature includes a display unit having a display screen that displays data as text data or image data, a receiver that receives the data, and a processor for processing and storing the data and providing control to the display unit to display the data on the display screen.

### CROSS-REFERENCE TO RELATED APPLICATIONS

The present application is a Continuation of International Application No. PCT/US2005/012385 filed on Apr. 13, 2005 which claims priority under 35 U.S.C. §119(e) to provisional U.S. Patent Application No. 60/561,892, filed on Apr. 14, 2004, the disclosures of which are expressly incorporated by reference herein in their entireties.

### BACKGROUND OF THE INVENTION

1. Field of the Invention

The invention generally relates to an integrated material handling and display unit and, more particularly, to such a display unit for displaying text and graphical information such as advertisements, videos and other information and an accompanying system, which is particularly adapted for the retail restaurant industries.

2. Related Art

Many patrons in restaurants use restaurant-supplied trays to carry their food from a central food-dispatching area to individual tables. Such trays may be used in hospitals, retirement communities, mess halls, schools, or restaurants such as fast-food outlets, cafeterias, theme parks and other restaurants. Oftentimes, these patrons are alone and have nothing to read or view while they are eating. And, in instances where there is more than one patron in a party, such patrons may like restaurant “entertainment” as a point of conversation.

Similarly, many patrons in restaurants use restaurant-supplied beepers or drink coasters that are used to signal the patron that their table is ready. Oftentimes, these individuals have nothing to read or view while they are waiting for their table and would embrace some form of “entertainment.”

Accordingly, there is a need for a device that will provide additional entertainment and/or information before and/or during dinning that can be integrated together with a common restaurant item, such as a food tray, coaster, beeper or other utilitarian item.

### SUMMARY OF THE INVENTION

The invention meets the foregoing need in that it will provide additional entertainment and/or information before and/or during dinning and is integrated together with a material handling item, such as a food tray. While the invention has been illustrated and described with specific application to items in the restaurant field, the styled artisan will appreciate that the invention may have applicability to numerous other fields and uses where additional entertainment and/or information is desired to be integrated with a utilitarian item.

Accordingly, in one aspect of the invention a food service article includes a functional section configured and structured to handle and/or carry food, a display unit having a display screen that displays data as at least one of text data and image data, a receiver that receives the data, and a processor for processing and storing the data and for controlling the display unit to display the data on the display screen.

The article may further include at least one of a speaker and a headphone jack, and the processor may be configured to output the data as an audio signal to one of the speaker and the headphone jack. The input device may be structured and arranged as a human interface to receive input for the processor, and the processor operates in response to the input from the input device to display data on the display unit.

According to another aspect of the invention a method of displaying data on a food service article structured and configured to handle and/or carry food, includes the steps of displaying data as at least one of text data and image data on a display screen, receiving the data, and processing and storing the data and providing control to display the data on the display screen.

The method may further include receiving input for processing with an input device structured and arranged as a human interface, and operating in response to the input from the input device to display data on the display screen. The method may further include receiving the data from at least one of an internet connection, intranet, telephone, email, wireless connection, and a point of sale terminal, and transmitting the data to the food service article.

In yet another aspect of the invention a food service article includes means to handle and/or carry food, means for displaying data as at least one of text data and image data, means for receiving the data, and means for processing and storing the data and for controlling the display of data on the display screen.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1A shows an exemplary general schematic diagram of a display portion of a utilitarian item and associated components constructed according to the principles of the invention;

FIG. 1B is an exemplary embodiment of a base station and server constructed according to the principles of the invention schematically showing the display portion integrated in a utilitarian item;

FIG. 2 is an exemplary embodiment of an integrated food tray and display unit constructed according to the principles of the invention;

FIG. 3A is a partial, cross sectional view of an integrated food tray and display unit showing recharging terminals constructed according to the principles of the invention;

FIG. 3B is an exemplary top view showing recharging terminals according to the principles of the invention;

FIG. 3C schematically shows recharging terminals aligning regardless of tray orientation in accordance with the principles of the invention;

FIG. 3D shows recharging terminals of the tray along with a holder constructed according to the principles of the invention;

FIG. 4A is a partial cross sectional view of an integrated food tray and display unit showing how heating components constructed according to the principles of the invention may be incorporated into the tray; and

FIG. 4B is a top view of an integrated food tray and display unit illustrating how the heating components of the invention may be orientated and constructed according to the principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments, as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

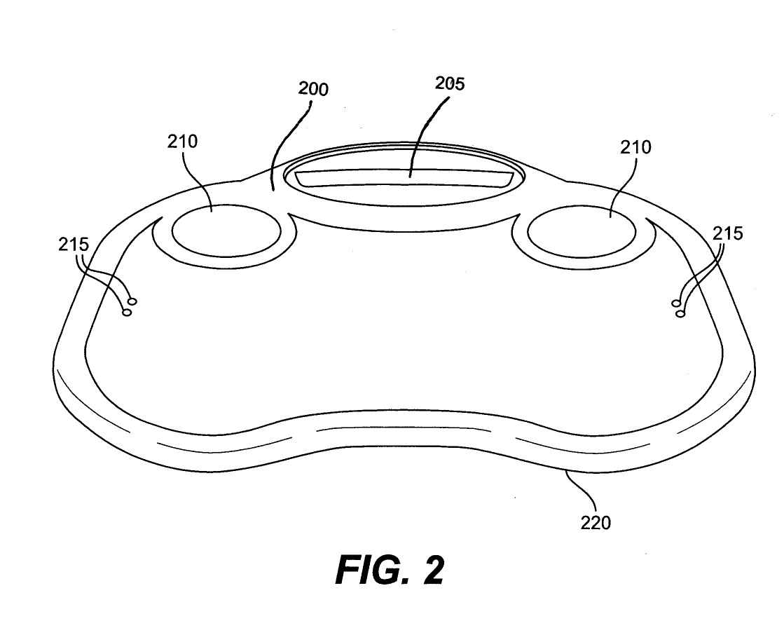

As noted above, the principles of the invention are described with non-limiting reference to the restaurant field and more particularly to a utilitarian item taking the form of a tray for carrying food. FIG. 2 shows one embodiment of an item 200 manufactured as plastic or metal tray. The tray 200 contains a built-in streaming text message display unit 205. Messages displayed on display unit 205 may be directed at patrons while they are, for example, eating their meals, waiting on line, etc. Content of the messages can be whatever the restaurant (or other organization) desires, including, but not limited to specials, promotions, entertainment, sports, news, community information, games, legal betting information, etc. Paid advertising content, such as “advertainment,” may also be displayed on display unit 205. Message creation, management and distribution, and processor operation may be handled essentially in the same manner as described in Assignee's U.S. Patent Application Publication No. 2004/0192399 entitled “Passive display unit and system and method of use” published Sep. 30, 2004, the disclosure of which is expressly incorporated by reference in its entirety herein.

The tray 200 may also be used to provide access to the Internet, as optionally offered by the restaurant or other institution. In this regard, a user may be quite inclined to check up on personal affairs, such as e-mail, while eating breakfast, lunch or dinner and the tray 200 may easily satisfy that desire.

With the tray 200, restaurant patrons may be exposed to a continually streaming set of text messages on a display unit 205 that can be tailored in length to match the average time a restaurant patron is in the restaurant. And, messages can be updated at any time. In this regard, it is contemplated that such messages may be modified by one or more of formatting, trafficking, and broadcasting across a restaurant chain's or other institutions entire network of stores internationally, nationally, regionally, or even locally.

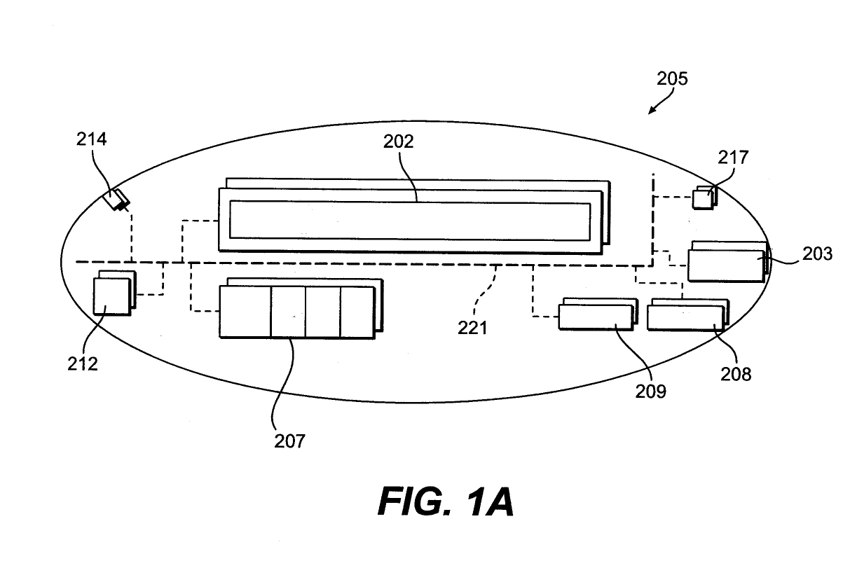

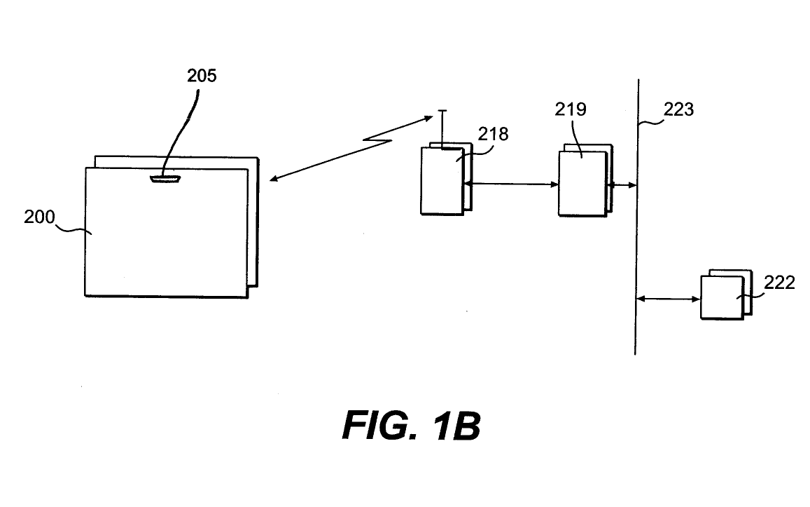

As shown in FIG. 1B, a display system that may be used in the invention includes a display unit 205 (shown in more detail in FIG. 1A) attached to or integrally formed in the tray 200. The transceiver 218 may be used to program the display unit 205 via infrared coupling, by the use of RF technologies, direct wired connection, or other transmission technologies and any future enhancements thereof. For example, CDMA, Bluetooth, Wi-Fi (802.11), fixed wireless access (IEEE 802.16 and other implementations), or any other known technology using a licensed or unlicensed frequency band may be used. Moreover, Universal Serial Bus (USB), Firewire™ (IEEE 1394), serial or parallel direct connections may also be used. However, it should be noted that any wired or wireless technology capable of transmitting data may be employed. In particular, the transceiver 218 can be used to program display unit 205 to the extent of upgrading data stored in display unit 205, and/or upgrading the operating system, firmware, and software of the display unit 205. The transceiver 218 may be programmed via a computer at a remote location connected through a network 223 or within the user environment. The display unit 205, may work independently, and may not include a transmitter or other type of signal generator.

The system is further designed in order to avoid the need for multiple transmitters and receivers throughout a space. Messaging is updated as needed. The display system is designed specifically to withstand extreme conditions for the intended application, here the retail restaurant or other food service establishment, such as commercial dishwashers, hence the materials for the tray 200 are designed to be water resistant. The materials contemplated for use with the display device to achieve the desired operational conditions may include, for example, engineering thermoplastics, gasketed metals, ultrasonic welding processes and other suitable materials and assemblies. While maintaining functional simplicity, minimal associated parts and components and low profile design to reduce chances of breakage. Also, the simple functionality and low power consumption components of the invention reduce power requirements, thus requiring smaller batteries and providing longer service life.

The transceiver 218 may be at a fixed location within the environment or may be a mobile transceiver 218, allowing the operator to program each tray 200 at any location, either simultaneously, separately, or any combination thereof. The transceiver 218 may be an off the shelf, commercially available transceiver 218 programmed to perform functions as discussed below, or may be designed for the specific application as an Application Specific Integrated Circuit (ASIC). The transceiver 218 may be under control of a server 219 which may also be serving, for example, the point of sale devices, such as restaurant cash registers 222 or other site devices.

The materials and assembly for the transceiver 218 are also designed to be water resistant. The materials and assemblies contemplated for use with the transceiver 218 to achieve the desired operational conditions may include, for example, engineering thermoplastics, gasketed metals, ultrasonic welding processes, and other suitable materials and assemblies.

The design of the transceiver 218 may comprise six hardware sections described below. In some embodiments, one or more of these hardware sections may not be necessary for a specific implementation. These hardware sections can be easily implemented and incorporated into the transceiver 218 by those of ordinary skill of the art. The transceiver 218 may be used to program the display unit 205 via infrared coupling, by the use of RF technologies, direct wired connection, or other transmission technologies and any future enhancements thereof. For example, CDMA, Bluetooth, Wi-Fi (802.11), fixed wireless access (IEEE 802.16 and other implementations), or any other known technology using a licensed or unlicensed frequency band may be used. Moreover, Universal Serial Bus (USB), Firewire™ (IEEE 1394), serial or parallel direct connections may also be used. However, it should be noted that any wired or wireless technology capable of transmitting data may be employed.

The transceiver 218 may be programmed via a computer at a remote location, or within the retail environment by Internet, or infrared, RF or other wireless mobile communication devices. The transceiver 218 may include the following components, off the shelf or otherwise: A receiver for receiving information and for decoding information as sent in a pre-determined protocol; A transmitter for transmitting information associated with the institution which is using the tray; A real time clock for maintaining time of day information; A Central Processing Unit (CPU) for controlling the operation of the display and communications. The CPU section may include low power memories and logic controls and may be one of any number of Intel™, AMD™, Sun™, Motorola™ or similar low power consumption processors; A power supply which may include rechargeable batteries or in embodiments other AC/DC inputs; A protected port connector for connection to an external computing device for receiving downloads, or the like; and, A key board for on-site programming of messages.

In one embodiment of the transceiver 218, an internal receiver will receive and decode Flex Protocol as defined within the Flex Protocol Version G1.9. The receiver, in one implementation, is capable of receiving a minimum of four cap codes, which may be field programmable.

Of course, it should be recognized that this is only one implementation of the invention, and that other implementations, including different frequencies and the like are contemplated by the invention. For example, the receiver, of course, may also be implemented using RF and/or infrared technologies, examples of which are discussed in detail herein.

In one implementation, the transceiver 218 further includes a transmitter designed to communicate at an effective data rate of approximately 115,200 bits per second and be of a sufficient intensity or signal strength to establish an error-free transmission at a distance of 18 inches. Error free in this case is defined to mean an averaged Bit Error Rate (BER) of less than three errors in one million bits.

In one implementation, the transceiver 218 is an infrared transmitter designed to communicate with the display unit 205. In another implementation, the transceiver 218 is a RF transmitter designed to communicate with the display unit 205. Both the infrared and RF may be implemented together, as well.

The transmitter system may additionally perform the following functions: Initiate (via a phone or other line) acquisition of new loop data, or receive loop data automatically; Store loop data locally; and/or Continually transmit loop data via RF broadcast.

In the RF implementation, the transmitter may have a Frequency Band of 902-928 MHz, and implement Frequency Hopping Spread Spectrum (FHSS) with a RF Power of up to 1 watt. The electrical interface may be an Ethernet-type Modular Connector (power and data). Additionally, the transceiver 218 may include an Omni-directional antenna.

In one implementation, the transceiver 218 further includes a real time clock, which may be designed to be accurate to one part in one million. The clock time should be settable with a command input from the transceiver 218 or a port. The port may also be used to program the transceiver 218. One of ordinary skill in the art will easily be able to implement and use the real time clock.

In one implementation, the transceiver 218 may also include a central processing unit (CPU) which can be any known CPU such as those designed by Sun™, AMD™, Intel™, or Motorola™ providing the desired functions. The CPU may include a random access memory (RAM) or read only memory (ROM). In the case of ROM, the CPU would be pre-programmed to perform many functions, as discussed below. The CPU may be hardwired, for example, to the components, of the transceiver 218 to provide functionality and control thereto. The CPU is preferably designed to perform the following functions, as can be implemented and understood by those of ordinary skill in the art: 1) Receive data from the Flex decoder and the port; 2) Receive data from phone lines, RF, or other types of transmissions; 3) Authenticate the received data is valid for the transceiver; 4) Separate data and commands structure packets buffering each for proper inclusion and execution; 5) Assemble the data in the proper form and sequence for download to the transceiver; 6) Strobe an LED indicator when a complete valid download exists; 7) Message and command memory being savable in the event of a power loss or failure; 8) Contain sufficient memory of various types to properly store at least two complete unique downloads, including, for example, a generic download message, provide any buffering, and an operational code area; 9) Receive, load, and change to alternate downloaded information such as different scrolling rates, different messages, uploading and/or upgrading the operating system and the like; 10) Perform automatic switching between transmitted message downloads on a time-based command; 11) Perform continuous transmitting of the Infrared data stream on external command; 12) Adjust the clock time with a received command; store and load cap codes with a time-based command; and 13) Store and change frequency with a time-based command. One of ordinary skill in the art can readily program such commands and functions.

The display device 205 may include the hardware sections or combination thereof as described below and shown schematically in FIG. 1A. The display device 205 may be a passive display which receives transmitted information from the transceiver 218, for example. In one implementation, the display device 205 does not include input user controls; however, the display device 205 may include a transmitter 203 for message verification as well as motion sensors 208 for detecting when the item is in use. In another implementation, the display device 205 may include input user controls 207 for full user interactivity. The user controls 207 may include any number of interactive alpha and/or numeric keys and, in embodiments, may include a miniature keyboard. These keys may be scanned for input by a CPU 209 for appropriate processing and display control. A user may use the display device 205 together with the keys of the user controls 207 to interactively select data that the user decides to view. User controls 207 may also allow the user to communicate with a web server or the like to surf the Web. In particular, user controls 207 are configured to allow input of a Universal Resource Locator (URL). The URL is transmitted by transmitter 203 to transceiver 218. Transceiver 218 will request a download from server 219 via network 223 and the download is then returned to tray 200 for display. Moreover user controls 207 will allow selection of links within the downloaded page. Accordingly, the ability to have the tray 200 communicate with a network, many restaurants may offer Internet access service to lure patrons to their business.

In one implementation, the display unit 205 and accompanying system is less complex and expensive than that of an interactive aspect of the display system. In embodiments, the display unit 205 may not include any buttons or other interactive devices which would require input from the user. Thus, messages are delivered to the display unit 205 without any interaction by the users. Consumption of content may be at the user's sole discretion, so messages may be embraced more positively.

The display unit 205 may include, for example, off the shelf components or otherwise, including: A logic or Central Processing Unit (CPU) 209 for controlling all display functions and communications with a base station or server; A motion sensor 208 for detecting when the tray 200 is in use and for activating the display; and A sleep timer for determining when the tray 200 has been inactive for a fixed period and for powering down a display module 202. The display module 202 displaying interactive or informational information to a user preferably on an LCD display module 202. The display 205 may also be, for example, a multiple line display depending on the particular application. The LCD display, in one implementation, is a non-backlit LCD. The display module 202 is driven by an LCD controller, which is an interface between the LCD display and the CPU 209. The display device 205 is designed for extreme temperature operation, and is UV and water resistant. In an alternative embodiment, the display screen may be, for example, a graphic display such as a plasma display screen, an organic light emitting diode (LED) display, or active matrix LCD display; A receiver incorporated in or in place of transmitter 203 for receiving information from a base station or centralized transceiver 218 for displaying the information on the display module 202; A power source module 212 which may be various types of batteries and may be charged by the contact terminals 215 (shown in FIG. 2); and component interconnection 221 that distributes power and transmits data to each of the components of display device 205.

Further features may include a web interface with the system of the invention. This may also include receipt of information via RF, paging technologies or other transmissions. This downloaded information may also be received from an intranet such as LAN, WAN, or Internet, for instance. This downloaded information may then be transmitted to the transceiver 218 (in embodiments under control of a network server 219 and base station, e.g., 218) at a fixed location or the display unit 205 within a retail environment such as within a store, via a radio frequency (RF) transmitter which broadcasts at an RF frequency. It should be understood that the transceiver 218 may be a unit located within the computer, itself. This is accomplished by having an RF transmitter associated with the computer implemented in a known manner.

In embodiments, and subject to the restaurant or other organization's desires, a customer may access the Internet for personal or business reasons, such as checking email or browsing.

The computer may include code stored in a solid state Compact Flash card, with no moving parts for storage. The software may include the responsibilities, as can be implemented by a programmer of ordinary skill, as described in Assignee's U.S. Patent Application Publication No. 2004/0192399 entitled “Passive display unit and system and method of use” published Sep. 30, 2004, the disclosure of which is expressly incorporated by reference in its entirety herein. The software may be upgradeable via the communication link to permit feature upgrades and customized text to be tailored to the customer application (e.g., the name of the restaurant as a default display).

In addition, the tray 200 may further include: streaming text and graphic messages in a highly visible information screen built into the nestable plastic or metal tray 200; The message screen will be designed and angled to be most easily read by a restaurant patron when they are sitting at a table eating their meal; and Messages created, controlled and updated from a central remote location may be delivered to tray 200 wirelessly via a single, small, in-restaurant transceiver 218 (e.g., a base station). The transceiver 218 may be used to program the display unit 205 via infrared coupling, by the use of RF technologies direct wired connection, or other transmission technologies. For example, CDMA, Bluetooth, Wi-Fi (802.11), fixed wireless access (IEEE 802.16 and other implementations), or any other known technology using a licensed or unlicensed frequency band may be used. Moreover, Universal Serial Bus (USB), Firewire™ (IEEE 1394), serial or parallel direct wired connection may also be used. However, it should be noted that any wireless technology capable of transmitting data may be employed. In particular, the transceiver 218 can be used to program display unit 205 to the extent of upgrading data, operating system, firmware, and software of the display unit 205.

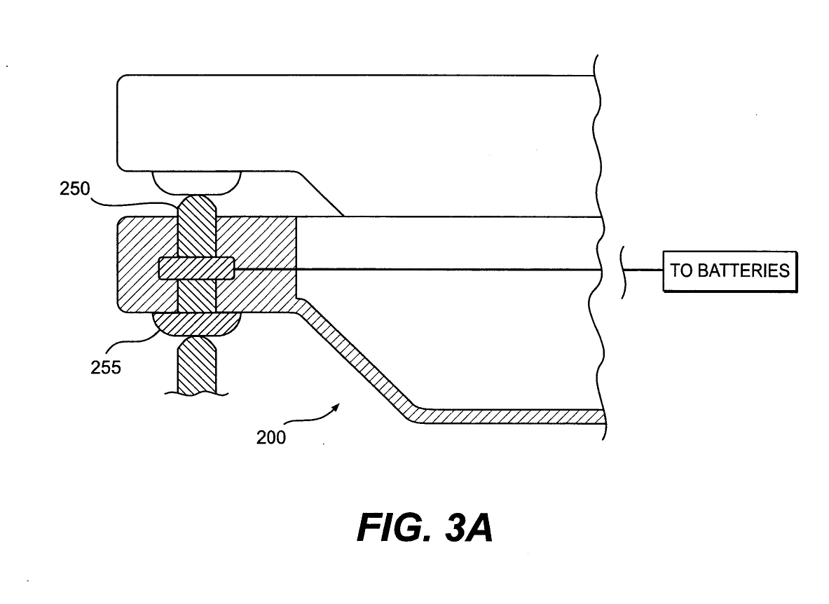

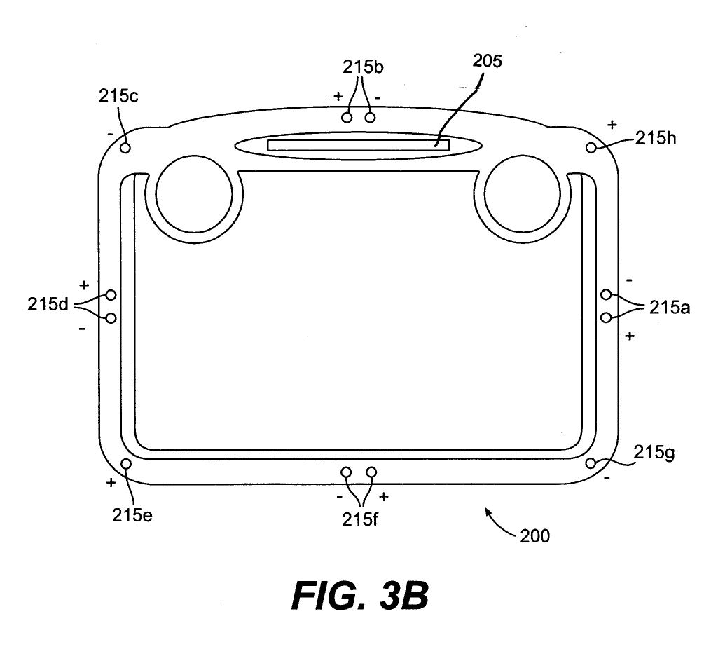

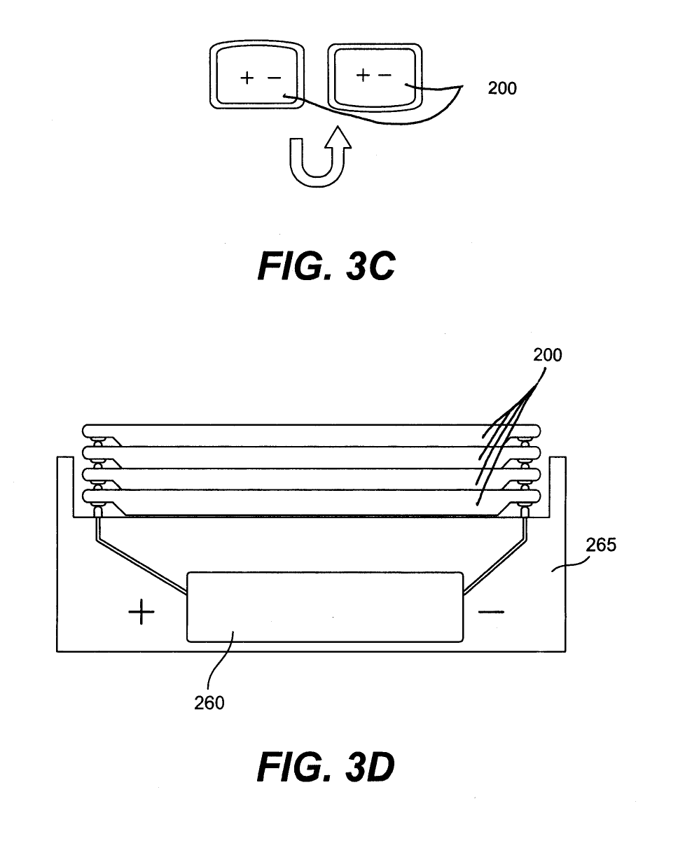

The tray 200 may be powered by rechargeable batteries or some similar power source (e.g., 212), and the recharging may take place with a recharger 260 when the nestable trays are stacked/re-stacked in a 265 dispensing unit shown in FIG. 3D. The tray 200 may include any number of terminals 215 (e.g., 215a-215h shown in FIG. 3B) as necessary depending on configurations of the tray 200. As shown in FIG. 3C, the tray 200 is configured to allow for the tray 200 to be stacked in several orientations so that the charging terminals still make contact with the correct charging polarity and are thus able to charge tray 200. FIG. 3D shows a centralized charging facility (e.g., dispensing unit 265) of the invention so that each tray 200 is charged when stacked via the terminals 215 (including top side terminal 250 and bottom side terminal 255 shown in FIG. 3A). The tray 200 may be stacked so that the top side terminals 250 contact an obverse side or bottom side terminal 255 of the contact on another tray 200. This allows for the distribution of charging electricity regardless of the number of trays 200.

In embodiments, the trays 200 may be charged using capacitive coupling charging methods which may not require contact terminals for charging. Alternatively the dispensing unit 265 may also serve as the message updating mechanism rather than the aforementioned wireless updating procedure (i.e., a communication protocol may be layered into charging circuitry of the charging components in the dispenser 265). In this regard, the charging contracts 205a-215h shown in FIG. 3B allow for both charging of the batteries or power source 212 and the transmission of data from transceiver 218 to each tray 200. The same configuration of charging contacts 215a-215h may be used to transmit data through the direct connection thereof to update the data in the tray 200 or to upgrade an operating system, software, or firmware of the tray 200.

The tray 200 is structured to withstand abusive environments over a long-period of time and may be able to withstand washing in a commercial dishwasher using the materials discussed above. The tray 200 may also include features 210 for receiving cups or food or the like. Portions 220 of the tray 200 may also include anti-skid texturing or surfaces for controlling movement of cups and plates, or the like as shown in FIG. 2.

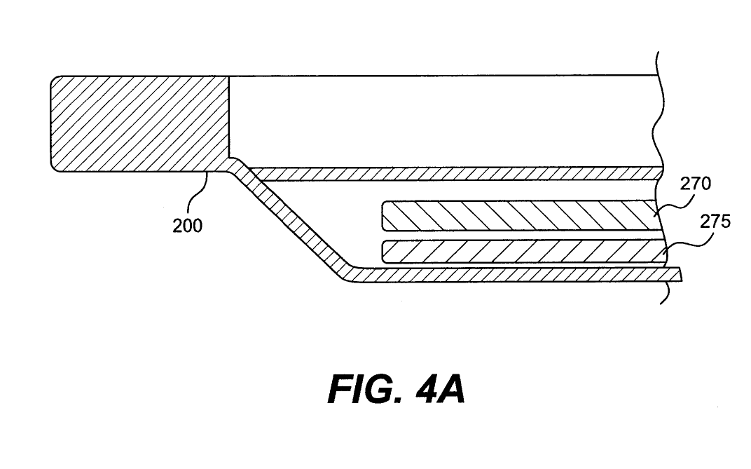

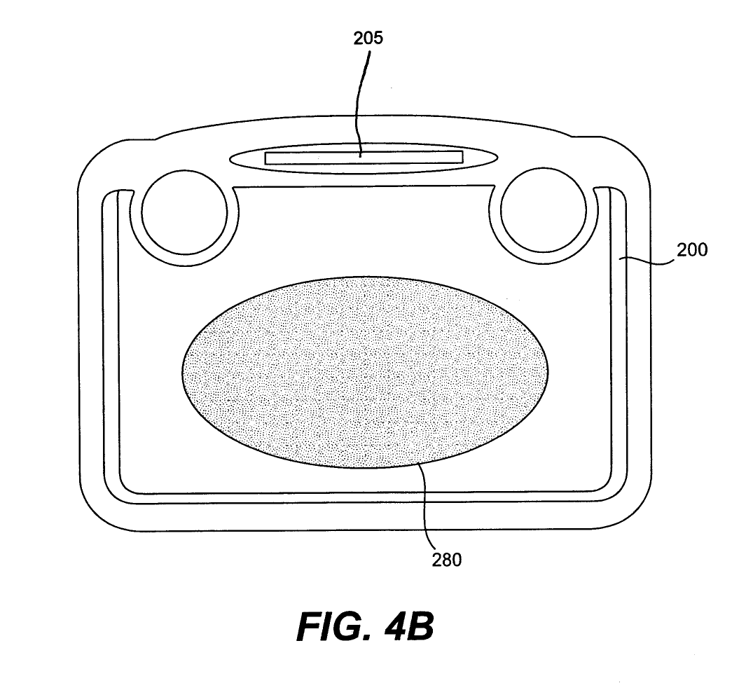

The tray 200 may have an optional feature of at least one “hot-spot” 280 in the tray 200 which will enable the tray 200 to keep warm food warmer for a longer time period as shown in FIG. 4B. As shown in FIG. 4A, this hot spot 280 may be provided by any known heating device 275 or device which is capable of retaining heat. A heat retaining material 270 (e.g., ceramic) may also be layered in the tray 200 for maintaining longer lasting heat distribution. In particular, the heating device 275 may be powered when in the disposer 265 so that a patron will have a warm tray 200 for keeping their meal warm. An external power supply may be optionally used for extended usage as an auxiliary power source when the “hot-spot” heating device 275 is used. The tray 200 may be available in a variety of colors with optional molded-in graphics and messages.

The tray 200 may or may not be interactive. However, the tray 200 may incorporate varying degrees of added functionality such as the ability to go back and review specific messages, pause the current message stream, etc., using interactive controls 207. This may be performed via a touchpad, touch screen, or such interactive controls like buttons or knobs.

The tray 200 may include a digital music feature allowing patrons to listen to music through headphones or personal headphones via headphone jack 214 shown in FIG. 1A. Selection of music channels may also be provided by interaction of user input 207 and display module 202. It is further contemplated that tray 200 may include a video monitor to allow viewing streaming video based on, for example, a digital format such as MPEG.

The tray 200 may also be coordinated with other functions associated with the providing institution. For example, the tray may be used in a restaurant for storing purchase receipt data for a customer on the display 205. This may be accomplished by coordinated communication with the cash register 222 (e.g., under control of a server 219 in communication with the tray 200 via a network 223). A customer's receipt may, for example, be transmitted to the tray 200 at the time of purchase. The restaurant may provide for accepting additional orders to be placed via a menu on the display 205, which is communicated through the network 223 and associated server 219 to an order taker where the order may be filled.

In another embodiment, in a hospital or nursing home, for example, an employee may identify themselves to the tray 200 (e.g., by entering an employee number or other identification) so that pages and broadcast messages may be directed to an individual while they are eating. In embodiments, the tray 200 may also sound an alert (e.g., speaker 217) if a message is of high importance. In embodiments, the employee may reply to a message through communication with tray 200.

Further, the user may transact personal business (e.g., financial transactions, banking queries, check on statuses, send messages, or the like) using the interactive display 205 of the tray 200 and connectivity to a network (e.g., Internet access via a base station and/or server).

In accordance with various embodiments of the invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the invention as described herein are optionally stored on a tangible storage medium, such as: a magnetic medium such as a disk or tape; a magneto-optical or optical medium such as a disk (e.g. compact disc (CD), Digital Video Disk (DVD)); a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A food service article comprising:
a functional section configured and structured to handle and/or carry food;
a display unit having a display screen that displays data as at least one of text data and image data;
a receiver that receives the data; and
a processor for processing and storing the data and for controlling said display unit to display the data on said display screen.

2. The article according to claim 1, wherein said display screen is one of a single or multiple line LCD display screen, a plasma display screen, a graphical display, organic light emitting diode (LED) display, and an active matrix LCD display; and wherein said processor includes memory for storing the data.

3. The article according to claim 1, wherein said receiver includes at least one of an infrared data port, a radio frequency (RF) port, a cellular port, and a direct-connection port that receive the data.

4. The article according to claim 1, further comprising:
at least one of a speaker and a headphone jack,
wherein said processor is configured to output the data as an audio signal to one of said speaker and said headphone jack.

5. The article according to claim 1, further comprising:
an input device structured and arranged as a human interface to receive input from a user for said processor; and
said processor configured to operate in response to the input from said input device to obtain and display data on said display unit,
wherein the input from the user comprises at least one of identification information, service request information, and data request information.

6. The article according to claim 1, further comprising at least one of a motion sensor and a timer to one of activate and deactivate at least one of said display screen, said receiver, and said processor; and
a power module to power said display screen, said processor, and said receiver.

7. The article according to claim 1, wherein said food service article comprises a tray and said functional section comprises at least one of surface and receptacle for carrying food.

8. The article according to claim 1, wherein said food service article comprises a tray, and said tray includes surfaces structured and arranged for increased utility.

9. The article according to claim 1, wherein said food service article comprises a tray, said tray includes charging contacts structured and arranged for charging a power module.

10. The article according to claim 1, wherein said food service article comprises a tray, said tray includes a hot spot to maintain a surface of said tray at an elevated temperature.

11. The article according to claim 1, wherein said receiver further comprises a transmitter that transmits information from said article,
wherein the information comprises at least one of identification information, service request information, and data request information.

12. The article according to claim 1, wherein said food service article comprises at least one of a tray, a coaster, and a beeper.

13. A system in combination with said article according to claim 1 comprising:
a transceiver configured to transmit the data to said article and receive information from said article,
wherein the data comprises at least one of text data, image data, software upgrades, firmware upgrades, and operating system upgrades.

14. The system according to claim 13 further comprising:
a server configured to receive the data from one of a internet connection, intranet, telephone, email, and wireless connection, and said server configured to forward the data to said transceiver.

15. The system according to claim 13 further comprising:
a point of sale terminal that forms data to be transmitted to said article and/or receives information from said article.

16. The system according to claim 13 further comprising:
a holder configured to receive said article and perform at least one of: 1) charging a power module of said article, 2) transmitting data from said transceiver to said article, and 3) heat said article.

17. The system according to claim 16 wherein said holder is configured to receive a plurality of said articles in a stacked configuration and to perform at least one of: 1) charging the power modules of said articles, 2) transmit data from said transceiver to said articles, and 3) heat said articles.

18. The system according to claim 17 further comprising:
charging contacts arranged on at least one of said articles, said contacts configured to at least one of charge the power modules, transmit the data to said articles, and heat said articles.

19. A method of displaying data on a food service article structured and configured to handle and/or carry food, said method comprising the steps of:
displaying data as at least one of text data and image data on a display screen;
receiving the data; and
processing and storing the data and providing control to display the data on the display screen.

20. The method according to claim 19, wherein said data receiving step comprises receiving data with at least one of an infrared data port, a radio frequency (RF) port, a cellular port, and a direct-connection port.

21. The method according to claim 19, further comprising:
outputting the data as an audio signal to one of a speaker and a headphone jack.

22. The method according to claim 19, further comprising:
receiving input from a user with an input device structured and arranged as a human interface; and
operating in response to the input from the input device to obtain and display data on the display screen,
wherein the input from the user comprises at least one of identification information, service request information, and data request information.

23. The method according to claim 22 further comprising:
receiving the data from at least one of an internet connection, intranet, telephone, email, wireless connection, and a point of sale terminal; and
transmitting the data to the food service article.

24. The method according to claim 22 further comprising:
transmitting information from said article,
wherein the information comprises at least one of identification information, service request information, and data request information.

25. A system comprising a food service article displaying data in accordance with the method of claim 19.

26. The system of claim 25, wherein said food service article comprises at least one of a tray, coaster, and beeper.

27. The method according to claim 19 further comprising the step of:
simultaneously charging a plurality of power modules of a plurality of the food service articles positioned in a stacked configuration in a holder through charging contacts.

28. The method according to claim 27 further comprising the steps of:
transmitting the data to the plurality of food service articles through the charging contacts,
wherein the data comprises at least one of text data, image data, software upgrades, firmware upgrades, and operating upgrades.

29. The method according to claim 28, wherein said step of data transmitting through the contacts comprises changing processor data.

30. A food service article comprising:
means to handle and/or carry food;
means for displaying data as at least one of text data and image data;
means for receiving the data; and
means for processing and storing the data and for controlling the display of data on said display screen.
